(19) United States
(12) Patent Application Publication
(10) Pub. No.: US 2010/0171670 A1
(43) Pub. Date: Jul. 8, 2010

(54) CONCEALED PLANAR ANTENNA

(75) Inventors: Joseph Jesson, Hamilton Square, PA (US); Thomas B. Breen, Broomall, PA (US); Patricia D. Mackenzie, Clifton Park, NY (US); Charles B. Theurer, Clifton Park, NY (US); William Pinto, Delran, NJ (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: General Electric Company, Stamford, CT (US)

(21) Appl. No.: 12/683,315

(22) Filed: Jan. 6, 2010

Related U.S. Application Data
(63) Continuation of application No. 10/938,458, filed on Sep. 10, 2004, now abandoned.

(51) Int. Cl. H01Q 1/32; H01Q 1/50; H01P 11/00

(52) U.S. Cl. 343/713; 343/860; 29/600

(57) ABSTRACT

The invention involves a radio frequency (RF) antenna, having both reduced size and optimized impedance matching to free space over a range of wavelengths. The invention also involves methods for hiding an antenna by reducing its size and concealing it behind or within an object that is transparent to electromagnetic waves over a range of wavelengths being transmitted or received by the antenna.

### FIELD OF THE INVENTION

The invention is in the field of RF antennas. More specifically, it concerns RF antennas that are reduced in size. It also concerns methods for concealing such antennas.

### BACKGROUND OF THE INVENTION

Radio Frequency (RF) communication technology is becoming ever more widespread. Such developments as portable wireless telephones and widely available satellite-assisted communications are motivating for a host of applications. A consequence is a proliferation of RF antennas. The physics of RF transmission and reception often requires these antennas to be rather large on a human scale, often comparable to the wavelength of the waves being transmitted and received. These antennas are thus highly visible and sometimes considered intrusive. This provides motivation for investigating ways to conceal or disguise such antennas. Another motivation for concealing an antenna is to protect it from vandalism. Still another motivation is to improve the overall security of a covert monitoring system.

One way an antenna can be hidden from view is to hide it behind or within another object. The object may itself have its own function or it may be designed simply to hide the antenna, perhaps while resembling an everyday object. For example U.S. Pat. No. 5,349,362 to Forbes, et. al., discloses an antenna hidden inside a vent pipe on a roof. Publication WO 01/35116 A1 of Kelly et. al. discloses an antenna hidden within a marker light housing attached to a mobile vehicle. U.S. Pat. No. 6,222,503 to Gietema, et. al. concerns antennas hidden using what appear to be other everyday objects. If the object hiding the antenna is solid, or nearly so, it must be made of a material largely transparent to the electromagnetic waves being transmitted or received by the antenna.

To further aid the concealing of an antenna, the size of the antenna can be reduced. This, however, is not straightforward. As mentioned above, in the absence of extraordinary measures an RF antenna, if it is to work efficiently, with minimal waste of RF energy, must have dimensions comparable to that of the wavelength it is designed to handle. Another related fact, also dictated by physics and well known in the radio-frequency art, is that in order to operate efficiently the “characteristic impedance” (also referred to simply as “impedance”) of the antenna must be “matched” to that of the medium into which the antenna is radiating or from which it is receiving—often air, or “free space.” The impedance of the antenna is affected by many material and geometrical factors, including its size, shape, material, and the manner in which it is connected to an RF generator or receiver.

As the operating wavelengths of the antenna increase, therefore, the necessary size of the antenna may increase, which may make hiding the antenna more difficult. One example illustrating this problem is the use of satellite antennas mounted on mobile vehicles, such as commercial tractor-trailers used to transport goods. These antennas may be used to transmit and receive signals used to locate and otherwise monitor the condition of the trucks and their contents. It is highly desirable to conceal such antennas in order to protect them from vandalism and to maintain the overall integrity and security of the locating and monitoring system. Some such antennas operate in the Very High Frequency or VHF range of the RF spectrum, commonly defined in the art as frequencies between about 30 and about 300 MHz, corresponding to wavelengths between about 10 meters and about 1 meter, respectively. An antenna of comparable size attached to a truck is not easily concealed. Hence, there is a need for antennas of reduced size which can be concealed or disguised and which still operate efficiently within their design wavelength range.

One way to reduce the size of an RF antenna is to construct the antenna in a planar configuration with a layer of dielectric material; these are often referred to as patch antennas or planar antennas. The dielectric material may have a dielectric constant εᵣ greater than 1.0, where εᵣ is the ratio of the permittivity ε of the material to that of free space, often denoted ε₀. The wavelength of electromagnetic waves propagating in the material is reduced from its free-space value by a factor of 1/√εᵣ. This phenomenon may be exploited to reduce the size of a planar antenna by essentially the same factor in both of the two dimensions defining the plane of the antenna. However, in order to maintain the efficiency of the antenna, additional measures must be taken to optimize the impedance matching.

U.S. Pat. No. 6,677,901 to Nalbandian, cited above, discloses a reduced size, impedance matched planar antenna, but is limited to a relatively narrow class of dielectric materials in order to achieve impedance matching, namely those with a permittivity-to-permeability ratio between about 1:1 and about 1:3. U.S. Pat. No. 5,349,362 to Forbes, et. al., cited above, and U.S. Pat. No. 5,757,324 to Helms, et. al., disclose concealed antennas that are essentially one dimensional (i.e. essentially linear rather than planar) and reduced in size in essentially only that one dimension. For some applications, such as mobile antennas operating at longer wavelengths, such linear antennas, even while reduced in one-dimensional size, may not be easily concealed. Publication WO 01/35116 A1 and U.S. Pat. No. 6,222,503, both cited above, do not address antenna size reduction as a means toward concealment. Additionally, the latter reference is mainly concerned with antenna arrays at fixed base stations.

There is therefore a need for a type of efficient, concealed antenna having both reduced size and optimized impedance matching to free space over its range of operating wavelengths, and which is relatively simple to construct, using a relatively broad range of materials.

### BRIEF DESCRIPTION OF THE INVENTION

The invention involves a concealed radio frequency (RF) antenna, comprising at least one ground plane, at least one active element, and at least one layer of dielectric material. The invention also involves hiding the antenna by reducing its size and concealing it behind or within an object that is transparent to electromagnetic waves over a range of wavelengths being transmitted or received by the antenna.

The antenna has an overall planar configuration. Its overall linear dimensions are significantly reduced, compared to other antennas operating in the same wavelength range. This is achieved in part by using a dielectric material having a dielectric constant εᵣ exceeding 1.0 (as explained above), along with a permittivity-to-permeability ratio exceeding 1:1. The latter ratio is defined as a εᵣ/μᵣ, where εᵣ is defined above and μᵣ is the ratio of the magnetic permeability μ of the material to that of free space, often denoted μ₀.

At the same time, the impedance matching of the antenna to free space over its operating range of wavelengths is optimized by carefully selecting such variables as shape details, the position of attachment of a coaxial feed cable, and the termination of the cable, including the termination at the point where the cable is electrically connected to the active transmitting or receiving element. Impedance matching is achieved by varying such variables as these and measuring the voltage standing wave ratio (VSWR).

The reduced-size antenna may be disguised by hiding it behind or within an object which is transparent, or nearly so, to the operating wavelengths of the antenna. In one embodiment, not to be construed as limiting the scope of the invention, this object may be in the shape of another familiar object. One example of the latter would be an object normally regarded as an integral part of a mobile vehicle, such as a louver vent, nose rail, bumper, body patch, corner protector, corner vent, or marker light. In another embodiment, the antenna could be hidden behind or within an object resembling a portion of a shipping container. Such an antenna could be used to convey, as examples, information about the location, contents, and state of security of the container to a distant location.

### DESCRIPTION OF FIGURES

FIG. 1 shows the front side of one embodiment of the reduced-size antenna, the side with an active element.

FIG. 2 shows the rear side of the same embodiment shown in FIG. 1, the side showing a ground plane.

FIG. 3 shows a cross section of the embodiment through the cut lines indicated in FIG. 1.

FIG. 4 shows one embodiment of an object that can be used to hide an antenna.

FIG. 5 shows one embodiment of a reduced-size, hidden antenna in place on a mobile vehicle.

### DETAILED DESCRIPTION OF THE INVENTION

What follows is a detailed description of specific embodiments of concealed antennas in accord with the present invention, and is not to be construed as limiting.

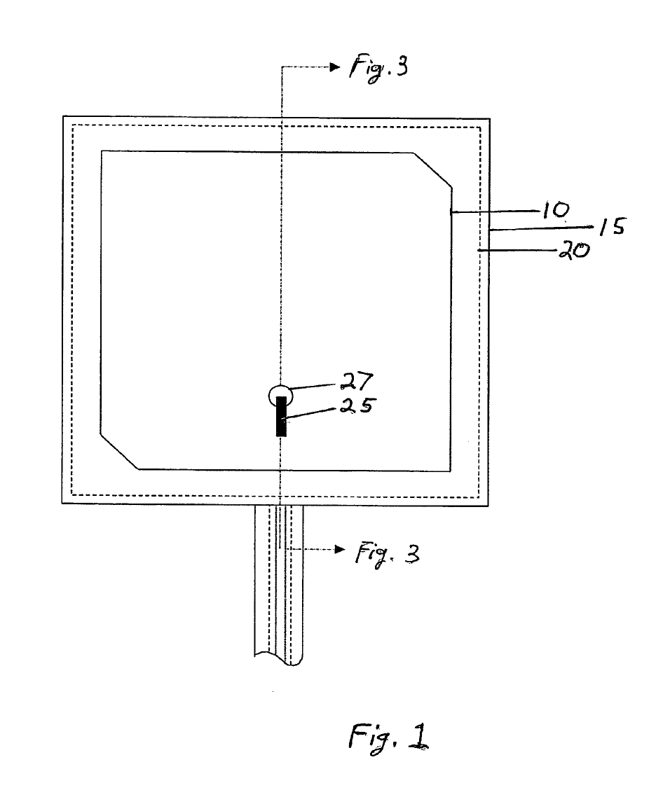

FIG. 1 is a front view of one embodiment of a reduced size antenna. A single active element 10 is fashioned from a layer of electrically conducting material and has the shape of a convex polygon. (A polygon is convex if, and only if, all of its angles, measured in its interior, are less than 180 degrees.) The active element 10 is integral with a dielectric layer 15. On the opposite side of the dielectric layer 15 is a ground plane 20, fashioned from another layer of electrically conducting material. The end of the center conductor of a coaxial cable 25 is connected to the active clement 10 and conveys RF energy to or from this element. The cable conductor 25 enters a small hole 27 from below and is soldered to the active element 10. The position of the cable end 25 on the active element 10 is chosen to optimize the impedance matching of the antenna to the source of RF energy, to free space, or to both. Alternatively, additional circuit elements, such as inductors or capacitors, could be situated between the cable end 25 and the active element 10 to further improve the impedance matching.

The dielectric layer 15 has an effective relative dielectric constant εᵣ exceeding 1.0, along with a permittivity-to-permeability ratio, εᵣ/μᵣ exceeding 1:1. As explained above, the higher the value of εᵣ the more the size of the antenna can be reduced. One class of materials valuable for this application is the so-called ferroelectric materials, some having εᵣ as high as 100 or more. This class includes, but is not limited to, titanium dioxide, titanium oxide, titania, barium titanate, and rutile.

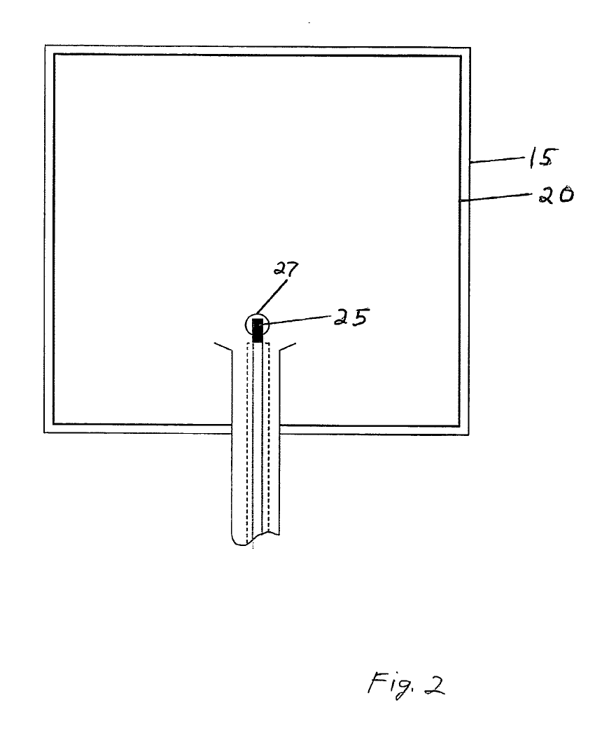

FIG. 2 shows a back view of the same embodiment, more clearly showing the ground plane 20 with numbering equivalent to that in FIG. 1.

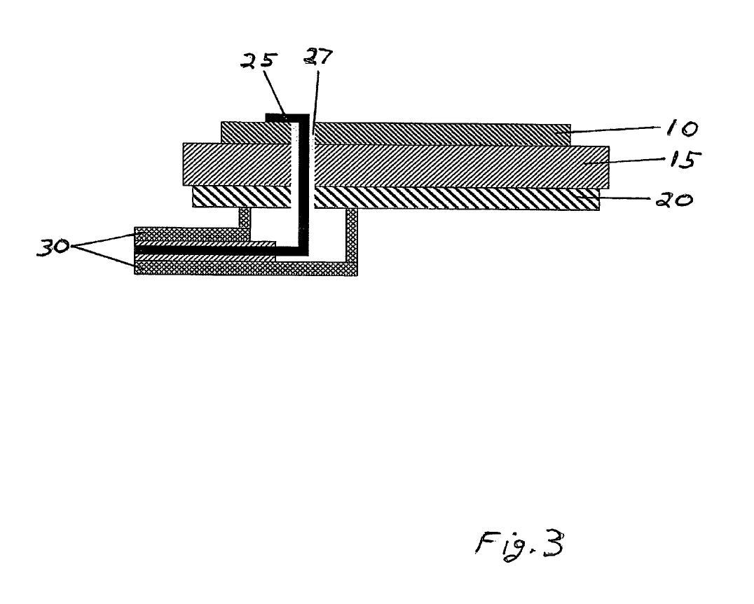

FIG. 3 shows a cross section the same embodiment of the antenna as that shown in FIGS. 1 and 2 with numbering equivalent to that in those figures. This Figure shows one embodiment of one portion of a feed circuit used to convey RF energy to or from the antenna. The outer conductor 30 of a coaxial cable is connected to the ground plane 20, while the inner conductor 25 of the same cable is connected to the active element 10. As explained above, the positions of these connections are chosen in such a way as to achieve optimized impedance matching of the antenna to its environment. In this particular embodiment, there is no aperture coupling of electromagnetic energy between elements.

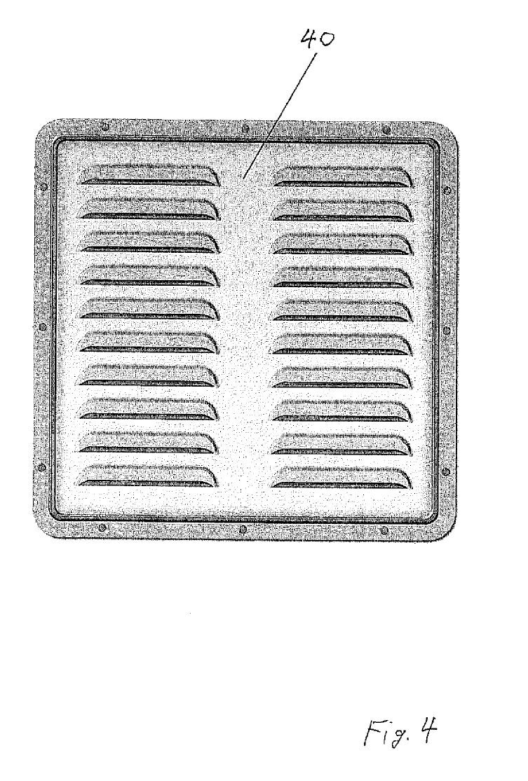

FIG. 4 shows one embodiment of an object 40, which can be used to hide the antenna. It is in the shape of a grill commonly used to cover vent openings on commercial trailers. The object 40 is fabricated from a material transparent to the operating wavelengths of the antenna. Some such materials are sometimes called “radome” materials and are known in the art.

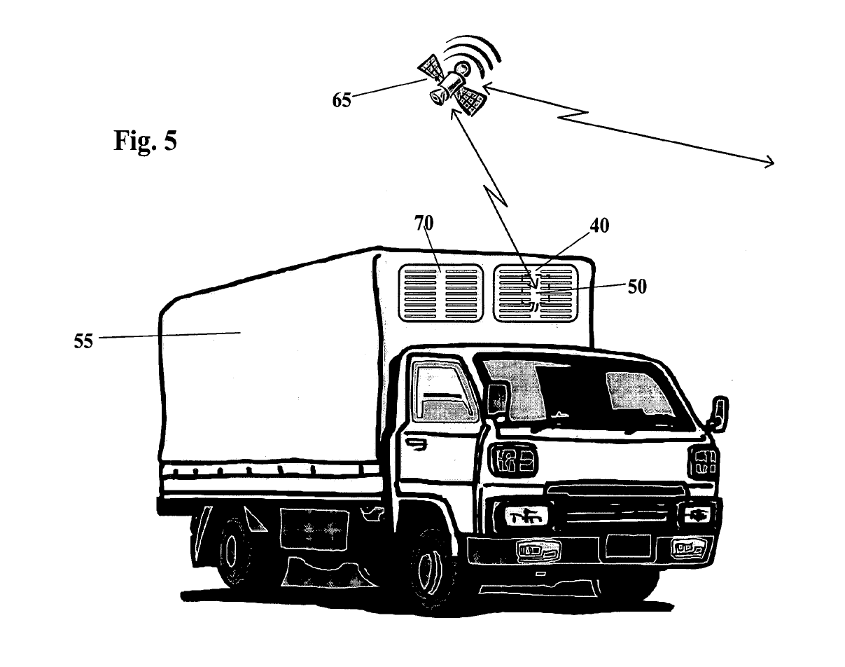

FIG. 5 shows an embodiment of an installed, reduced-size, hidden antenna. In this embodiment, a planar antenna, 50, is attached to a mobile vehicle 55 and is used to exchange information concerning the vehicle and its contents with a remote location via a satellite 65. The antenna 50 is hidden behind an object 40 in the shape of a vent cover, which is an integral part of the vehicle. Also depicted is an actual vent cover 70 on a different part of the vehicle 55. Because both objects appear identical to a casual observer, and because such vent covers are commonly seen and understood to be vent covers, the observer is less likely to imagine an antenna hidden behind one of them.

It is to be understood that the descriptions and embodiments described above are exemplary, and are not to be taken as limiting the scope of the invention. Alternatives, modifications, and variations, which do not depart from the spirit and scope of this invention, will be apparent to those skilled in the art. The scope of this invention is to be defined by the following claims:

What is claimed is:

1. A concealed antenna, comprising:
a planar radio frequency (RF) antenna having both reduced size and optimized impedance matching to free space over a range of wavelengths, said antenna comprising:
at least one ground plane,
at least one active element,
at least one layer of dielectric material having a dielectric constant exceeding 1.0 and a permittivity to permeability ratio exceeding 1:1, and
at least one feed circuit, said feed circuit comprising at least one conducting cable, the end of said conducting cable being electrically connected to, and positioned on, said at least one active element in such a way as to achieve said optimized impedance matching;
wherein said planar RF antenna is placed behind or within a camouflaged object, thereby preventing said planar RF antenna from being identified, wherein said object is transparent to electromagnetic waves of said range of wavelengths.

2. The concealed antenna of claim 1, wherein said object is camouflaged to appear as an integral part of a mobile vehicle.

3. The concealed antenna of claim 1, wherein said object is camouflaged to appear as an integral part of a shipping container.

4. The concealed antenna of claim 1, wherein said object has the appearance of a louver vent, nose rail, bumper, body patch, corner protector, corner vent, or marker light.

5. The concealed antenna of claim 1, wherein said range of wavelengths is the VHF range.

6. The concealed antenna of claim 1, wherein said dielectric material is a ferroelectric material.

7. The concealed antenna of claim 1, wherein said dielectric material is selected from the group consisting of titania, titanium oxide, titanium dioxide, barium titanate, and rutile.

8. The concealed antenna of claim 1, wherein said dielectric material has a dielectric constant exceeding about 2 and a permittivity to permeability ratio exceeding about 2:1.

9. The concealed antenna of claim 1 lacking aperture coupling.

10. A concealed antenna, comprising:
a planar, radio frequency (RF) antenna having both reduced size and optimized impedance matching to free space over a range of wavelengths, said antenna comprising:
a first conducting layer, acting as a ground plane,
a second conducting layer opposite said first layer, said second layer acting as an active element,
a layer of dielectric material situated between said first and said second conducting layers, said material having a dielectric constant exceeding 1.0 and a permittivity to permeability ratio exceeding 1:1, and
a feed circuit, said feed circuit comprising at least one conducting cable, the end of said conducting cable being electrically connected to, and positioned on, said at least one active element in such a way as to achieve said optimized impedance matching;
wherein said planar RF antenna is placed behind or within a camouflaged object, thereby preventing said planar RF antenna from being identified, wherein said object is transparent to electromagnetic waves of said range of wavelengths.

11. The concealed antenna of claim 10, wherein said object is camouflaged to appear as an integral part of a mobile vehicle.

12. The concealed antenna of claim 10, wherein said object is camouflaged to appear as an integral part of a shipping container.

13. The concealed antenna of claim 10, wherein said object is camouflaged to appear as a louver vent, nose rail, bumper, body patch, corner protector, corner vent, or marker light.

14. The concealed antenna of claim 10, wherein said range of wavelengths is the VHF range.

15. The concealed antenna of claim 10, wherein said dielectric material is a ferroelectric material.

16. The concealed antenna of claim 10, wherein said dielectric material is selected from the group consisting of titania, titanium oxide, titanium dioxide, barium titanate, and rutile.

17. The concealed antenna of claim 10, wherein said dielectric material has a dielectric constant exceeding about 2 and a permittivity to permeability ratio exceeding about 2:1.

18. The concealed antenna of claim 10 lacking aperture coupling.

19. A method of concealing an RF antenna, the method comprising:
creating a planar radio frequency (RF) antenna having both reduced size and optimized impedance matching to free space over a range of wavelengths, said antenna comprising:
at least one ground plane, at least one active element,
at least one layer of dielectric material having a dielectric constant exceeding 1.0 and a permittivity to permeability ratio exceeding 1:1; and
at least one feed circuit, said feed circuit comprising at least one conducting cable, the end of said conducting cable being electrically connected to, and positioned on, said at least one active element in such a way as to achieve said optimized impedance matching; and
concealing said planar antenna behind or within a camouflaged object, said object being transparent to electromagnetic waves of said range of wavelengths.

20. The method of claim 19, wherein said object is camouflaged to appear as an integral part of a mobile vehicle.

21. The method of claim 19, wherein said object is camouflaged to appear as an integral part of a shipping container.

22. The method of claim 19, wherein said object is camouflaged to appear as a louver vent, nose rail, bumper, body patch, corner protector, corner vent, or marker light.

23. The method of claim 19, wherein said range of wavelengths is the VHF range.

24. The method of claim 19, wherein said dielectric material is a ferroelectric material.

25. The method of claim 19, wherein said dielectric material is selected from the group consisting of titania, titanium oxide, titanium dioxide, barium titanate, and rutile.

26. The method of claim 19, wherein said dielectric material has a dielectric constant exceeding about 2 and a permittivity to permeability ratio exceeding about 2:1.

27. The method of claim 19 wherein said planar RF antenna lacks aperture coupling.

28. A method of concealing an RF antenna, the method comprising:
creating a planar radio frequency (RF) antenna having both reduced size and optimized impedance matching to free space over a range of wavelengths, said antenna comprising:
a first conducting layer, acting as a ground plane,
a second conducting layer opposite said first layer, said second layer acting as an active element,
a layer of dielectric material situated between said first and said second conducting layers, said material having a dielectric constant exceeding 1.0 and a permittivity to permeability ratio exceeding 1:1, and
a feed circuit, said feed circuit comprising at least one conducting cable, the end of said conducting cable being electrically connected to, and positioned on, said at least one active element in such a way as to achieve said optimized impedance matching;
and
concealing said planar antenna behind or within a camouflaged object transparent to electromagnetic waves of said range of wavelengths.

29. The method of claim 28, wherein said object is camouflaged to appear as an integral part of a mobile vehicle.

30. The method of claim 28, wherein said object is camouflaged to appear as an integral part of a shipping container.

31. The method of claim 28, wherein said object is camouflaged to appear as a louver vent, nose rail, bumper, body patch, corner protector, corner vent, or marker light.

32. The method of claim 28, wherein said range of wavelengths is the VHF range.

33. The method of claim 28, wherein said dielectric material is a ferroelectric material.

34. The method of claim 28, wherein said dielectric material is selected from the group consisting of titania, titanium oxide, titanium dioxide, barium titanate, and rutile.

35. The method of claim 28, wherein said dielectric material has a dielectric constant exceeding about 2 and a permittivity to permeability ratio exceeding about 2:1.

36. The method of claim 28 wherein said planar RF antenna lacks aperture coupling.
